(19) United States
(12) Patent Application Publication
(10) Pub. No.: US 2025/0347121 A1
(43) Pub. Date: Nov. 13, 2025

(54) FACADE PANEL FASTENING SYSTEM

(71) Applicant: SFS Group International AG, Heerbrugg (CH)

(72) Inventor: Yves PÖLTINGER, St. Margrethen (CH)

(73) Assignee: SFS Group International AG, Heerbrugg (CH)

(21) Appl. No.: 19/278,920

(22) Filed: Jul. 24, 2025

Related U.S. Application Data
(63) Continuation-in-part of application No. 19/036,305, filed on Jan. 24, 2025.

(30) Foreign Application Priority Data
Jan. 25, 2024 (EP) 24154013.7

(51) Int. Cl. E04F 13/08; F16B 3/00; F16B 5/04

(52) U.S. Cl. CPC E04F 13/0816; F16B 3/00; F16B 5/04

(57) ABSTRACT

A fastening arrangement for connecting a façade panel and a panel holder is provided. The façade panel is a panel with a homogeneous structure; with a front side, a material layer and a rear side. A keyhole-shaped groove is provided on the rear side of the facade panel having a widened insertion opening and a retaining area with an undercut in the material layer. The mechanical connection between the facade panel and the panel holder is a riveted connection using a rivet with a mushroom-shaped head inserted through the insertion opening and into the undercut of the retaining area. The panel holder is pushed onto a free end of the rivet shank that extends out via a through-opening so that the panel holder rests on the cover panel. The rivet shank free end is then formed by a rivet setting tool to create a positive fit between the composite panel and the panel holder.

### CROSS-REFERENCE TO RELATED APPLICATIONS

This application is a continuation-in-part of U.S. patent application Ser. No. 19/036,305, filed Jan. 24, 2025, which claims priority from European Patent Application No. 24154013.7, filed Jan. 25, 2024, both of which are incorporated herein by reference as if fully set forth.

### TECHNICAL FIELD

The present invention relates to a method for manufacturing a fastening arrangement comprising a façade panel as well as a panel holder and a rivet suitable for carrying out this method; as well as the fastening arrangement itself. The field of application thus relates to the fastening of façade elements such as wall, ceiling or roof cladding panels (façade panels) to a building structure or a substructure, in particular in the design as a ventilated rainscreen façade (VHF).

### BACKGROUND

Today, the building envelope is understood to be the entirety of all components that seal off a building from the outside. Considering the cross-section of an exemplary building envelope from the inside to the outside, an insulation layer is usually placed on a structurally load-bearing component (wall, roof, ceiling) and a curtain wall element is placed in front of it, spaced by a ventilation gap. This façade element is mechanically attached to a substructure, which is usually connected directly to the load-bearing wall via a metal structure.

In modern residential and commercial construction, the building envelope has to fulfill a variety of complex functions, i.e. mechanical protection, thermal and acoustic insulation and an attractive design.

The task of the ventilated rainscreen façade is therefore to cover the functional layers as the outer finish of the building envelope and to protect them from environmental influences. The installation of the façade elements or façade panels must be simple and secure, their anchoring must be able to withstand pressure and wind suction forces, and they must meet the aesthetic demands of the architecture.

### Definitions

In the following, “façade elements” are generally understood to mean components that are to be attached to a substructure as part of a building envelope. These façade elements are usually large, flat and have a square or rectangular basic shape. They are often made of metal, fiber cement, plastics, natural stone or composite materials.

Inter alia, this description refers to “composite panels” or sandwich panels, which are also referred to as ACM panels. ACM stands for aluminum composite material; these panels consist of a rear cover sheet facing the substructure, a visible sheet facing away from it and a usually non-metallic core layer between these sheets. The sheets are usually made of 0.5 mm thick aluminum, the core layer often consists of flame-retardant, mineral-filled polyester or mineral fillers with polymer binders. The total thickness of the composite panels is usually 3-6 mm. This description uses the terms composite panel and sandwich panel to refer to all panels with a cover sheet on the back and a visible sheet on the front and a non-metallic core layer in between. Technically equivalent panel structures with cover layers and core materials of similar structure and/or function are included.

Furthermore, the present description also refers to “façade panels” which are not considered as sandwich panels, but which can be used with the present invention. This primarily refers to panels with a homogeneous structure or, in other words, panels with a uniform structure made of a uniform material. Due to the type of fastening, the façade panels will have a minimum thickness of 3.5 mm. Depending on the context in this description, the term “panel” can mean both a façade panel and a composite panel—especially if the technical description applies to both variants.

The material of the façade panels themselves may have a heterogeneous composition, as in the example of fiber cement; a mixture of a mineral binder and synthetic fibers. Post-treatment of surfaces, such as anodizing, texturing, coating, oxidizing and applying paint, shall not be considered a deviation from the “uniform material” principle. The attachment of decorative or functional elements to a façade panel should also not be considered a deviation from this definition. Possible materials are therefore, among others:
(A) HPL (High Pressure Laminate) is a robust laminate made from layers of paper impregnated with synthetic resin and pressed under high pressure. The resulting board is particularly durable, impact-resistant, scratch-resistant and light-resistant. HPL is used in many areas, including furniture construction, interior design and exterior applications.
(B) Fiber cement is a composite material made from cement, water, fibers and additives. It is characterized by its durability, weather resistance and non-combustibility, which makes it a popular material for roofs and facades in sheet form. In the past, asbestos was often used as fiber, but today synthetic fibers are used.
(C) Ceramics is a generic term for molded and fired products that are used as utility and decorative objects as well as building components. Ceramic materials are defined as inorganic, non-metallic, hardly soluble in water and at least 30% crystalline. As a rule, they are formed from a raw mass at room temperature and obtain their typical material properties through heat treatment, usually above 800° C.
(D) Porcelain stoneware is a commonly used term for ceramic tiles with very low water absorption. They can be used unglazed, but are also available glazed, colored, textured, printed and/or polished. It is a very compact product that is sintered through at a firing temperature of usually 1200-1300° C. and whose main characteristic is its low porosity with a water absorption of <0.5%. Due to its low water absorption, porcelain stoneware is frost-resistant and can therefore also be used outdoors.
(E) Light metal tiles: Thin metal panels (sheets) have also been used as façade panels for a long time because they can be produced over large areas and are robust; a variety of surface structures and shapes can be achieved by embossing, punching, cutting and bending and the surfaces can be given weather protection by painting, anodizing or passivation. The rigidity of the panels can be improved by folding the edges. The light metals used are metal materials known and approved in the construction industry, primarily aluminum and its alloys, but also stainless steel.

“Retaining elements” are mechanical components that create a connection between a façade element, a composite panel, a façade panel and a substructure respectively. The retaining elements can be designed so that they are visible or deliberately invisible as part of a building envelope. In this context, invisible is understood to mean that they are not (or no longer) recognizable to an observer after completion of the building envelope. In the narrower sense of this description, a retaining element refers to a “panel holder” that can be attached to the back of a composite panel or façade panel and allows the panel as a whole to be at least temporarily attached to the substructure (e.g. hooked in). Panel holders are usually secured against falling or lifting (wind suction) by additional means on the substructure.

For the purposes of this description, a “substructure” is any device that allows composite panels or façade panels to be fixed in a defined position on the building with the aid of retaining elements, to absorb forces acting on the panel and to transfer them to the structural load-bearing component (building). For this purpose, a substructure usually has profile supports that can fulfill the function of a mechanical interface to the panel holder. A special variant of a substructure uses a horizontally arranged profile support of the same cross-section as the panel holder itself as a mount for a panel holder. This reduces the variety of materials.

For the purposes of the present invention, the term “rivet” refers to a pull-through rivet which consists of a rivet in the form of a hollow rivet sleeve with a pull-through mandrel. Pull-through mandrel means that the mandrel has a head at its rear end which is pulled completely through the hollow shank of the hollow rivet sleeve during the setting process. The term undercut rivet is also used due to its use in an undercut.

### PRIOR ART

Utility model DE G 93 08 171.5 shows the attachment of a retaining element to a composite panel by means of a threaded bolt. This threaded bolt has a flat bolt head at one end, which is inserted into a milled, undercut groove in the back of the panel. The shape of the bolt head is preferably non-circular, which ensures an anti-rotation lock in the undercut and facilitates subsequent screwing.

The publication EP 0 380 953 A1 shows a combination of panel holder and profile support with an identical cross-section. The panel holder consists of sections of the profile support and is designed in such a way that the panel holder can engage positively in the profile support in a 180° turned position. The aforementioned DE G 93 08 171.5 also shows a panel holder/profile support combination of this principle.

The publication WO 2017/067 907 A1 shows a façade fastening system for use with composite panels. The composite panel has a keyhole-shaped cutout on the rear side that extends into the core layer. The cut-out forms an insertion opening and an adjoining retaining area similar to an elongated hole, which is narrowed in comparison to the insertion opening in such a way that an undercut is created in the core layer. A fastener with a flat, mushroom-shaped head can be threaded through the insertion opening and is held in the narrowed retaining area. The fastener can be used to screw a panel holder invisibly to the rear. The keyhole is aligned so that the retaining area points upwards in the end position. Two keyholes can also be arranged in parallel so that a panel holder is secured with two fasteners.

In the prior art, the use of screw connections is often proposed when fastening a panel holder to a composite panel, which is a common and inexpensive fastening method. Non-rotating bolt heads are preferred because it is very difficult to counter the bolt head in the undercut with a tool. Self-locking nuts must also usually be provided to prevent any loosening of the screw connection due to seasonal temperature fluctuations and load changes (wind suction/pressure).

For technical reasons, the panel holder is movable in the longitudinal alignment of the keyhole during installation. If the panel holder is not pressed correctly into the end stop of the keyhole, the end position of the panel holder may be displaced from the target position. In addition, the position of the threaded bolt can be changed by the rotary movement during screwing, which is also disadvantageous. If self-locking nuts are used, subsequent correction is only possible with a great deal of force.

### SUMMARY

It is therefore the object of the invention to propose a processing-safe method and thus a fastening solution for a panel holder on the back of a composite panel or façade panel.

This object is achieved by the method having one or more of the features described herein, particularly using a rivet, which has one or more of the features described herein. A fastening arrangement according to the present disclosure is the result. Further useful variants and supplementary features are described below and in the claims.

The method describes the manufacture of a fastening arrangement consisting of a façade panel and a panel holder. The façade panel is designed as a panel with a homogeneous structure; with a front side, a material layer and a rear side. At least one keyhole-shaped groove having at least two sections is provided on the back of the façade panel. At its first longitudinal end, the groove has a first section with a widened insertion opening and, at the other longitudinal end, an elongated hole-shaped retaining area with an undercut in the material layer.

This groove has an illustrative keyhole shape in accordance with the prior art and comprises an elongated, slot-shaped opening with a widened circular or oval expansion of the slot. In the context of the present invention, the latter is arranged at the first longitudinal end and is referred to as the widened insertion opening. The other longitudinal end of the slot forms a slot-shaped retaining area with an undercut in the core layer or the material layer. Undercut means that in the retaining area of the groove, behind the rear cover panel of a composite panel or the rear side of a façade panel, the slot in the core layer/material layer is wider than the visible opening in the rear side. Such keyhole-shaped openings can be produced in a known manner in a single operation using undercut cutters.

Undercut cutters are available for the material combination(s) of composite panels as well as for the aforementioned materials of façade panels. The wall thickness required for the fastening method described below depends on several factors, e.g. the type of panels, their weight per unit area, the load-bearing capacity of the surface layer, core layer or material layer. Furthermore, the intended or prescribed number of panel holders per surface plays a role and whether the panel holders have one or more fixing points. A skilled person can experimentally find out whether and how loadable a specific fastening arrangement is by carrying out tensile tests on corresponding fastening arrangements.

The panel holder in turn also has at least one through-opening. The mechanical connection between the composite panel/façade panel and the panel holder is achieved by a setting process and a resulting riveted connection.

The rivet used comprises a mushroom-shaped head and a shank. The setting process is designed so that the head of the rivet is threaded through the insertion opening and then placed in the undercut of the retaining area of the groove in the composite panel or façade panel respectively. This causes the free end of the shank to protrude from the rear side.

In other words, the diameters of the rivet head and the insertion opening are selected so that the head of the rivet fits through the insertion opening in the composite panel/façade panel but is held in the elongated hole-shaped retaining area by the cover panel on the back.

If the rivet head is located in the façade panel or composite panel, the panel holder is placed on the free end of the shank of the rivet via its through-opening so that the panel holder rests on the rear side of the panel. The free end of the shank is then formed by a rivet setting tool so that the rivet creates a positive fit between the panel and the panel holder.

A rivet that is designed as a pull-through rivet, i.e. whose shank and head have a continuous axial through-opening with a diameter D_{I}, is particularly suitable. An associated pull-mandrel has a head with a diameter D_{K}>D_{I} and a pull-mandrel shank. The pull-mandrel shank is dimensioned so that it can be guided in the axial passage opening of the pull-through rivet with minimal play. Before setting the rivet or before threading it into the undercut of the composite panel/façade panel, the pull-mandrel is inserted through the axial through-opening of the rivet so that the head of the pull-mandrel rests against the head of the rivet and the pull-mandrel protrudes from the shank of the rivet.

The setting process is now effected by the rivet setting tool actuating the pull-mandrel to produce the riveted joint, thereby moving (pulling) the head of the pull-mandrel through the axial through-opening of the rivet and achieving a positive fit between the composite panel/façade panel and the panel holder by displacing the material.

The rivet setting tool preferably has a tubular mouthpiece with a substantially cylindrical cavity that is axially open on one side and a receptacle for the pull-mandrel shank arranged at the bottom of this cavity. For the setting process, the cavity of the mouthpiece is arranged (fitted over) above the free end of the shank in such a way that the rivet setting tool can grip the pull-mandrel shank in a functional manner. The mouthpiece is arranged with its open, ring-shaped end resting on the back of the panel holder. However, a non-contact gap of 0.1 mm-2 mm, preferably 0.3 mm-1 mm, remains between the free end of the shank of the rivet and the bottom of the cavity. In other words, at the start of the rivet setting process, when the rivet setting tool starts to pull the pull-mandrel through the axial through-opening, the shank end of the rivet is not in contact with the bottom of the cavity.

Any device that can hold a mouthpiece of the type described and actuate the pull-mandrel can be used as a rivet setting tool. There are, for example, versions with pneumatic or electric or battery-electric drive.

The movement of the head of the pull-mandrel along or through the axial through-opening(s) of the rivet causes a contact pressure between the mouthpiece resting on the back of the panel holder and the mushroom-shaped head of the rivet. This results in a displacement of the (rivet) material surrounding the axial through-opening both radially outwards and in the axial pulling direction of the pull-mandrel. However, the displacement of material in the axial pulling direction of the pull-mandrel is stopped after a certain time when the free end of the shank of the rivet strikes the bottom of the cavity. After this, the material is only displaced radially outwards.

During the setting process, the mandrel is pulled completely through the rivet and the material of the shank or sleeve is displaced radially outwards and partially in the direction of pull. This brings the material of the shank into a positive fit with the holes of the two connecting partners and creates a firm connection. In addition, where the sleeve of the rivet protrudes beyond the attached panel holder, a radial bead can be formed with an outer diameter larger than the through-opening in the panel holder.

The described geometric relationship between the mouthpiece and the shank end of the rivet ensures that the material displacement that takes place is initially possible both axially and radially. Once the shank end has struck the base of the mouthpiece, only radial material displacement is possible. This improves the quality of the riveted joint and handling safety.

The characteristics of the pull-through rivet described above, which is particularly suitable for carrying out the method, can be described as follows. The rivet will essentially have a shank and a head, wherein the head and shank have a continuous axial through-opening with diameter D_{I}. Furthermore, a pull-mandrel with a head having a diameter D_{K}>D_{I} and a longitudinally extended pull-mandrel shank is provided, wherein the pull-mandrel can be inserted into the axial through-opening of the rivet in such a way that the head of the pull-mandrel rests against the head of the rivet.

The rivet can also advantageously have an axially deepened recess on the upper side of the mushroom-shaped head facing away from the shank, which is dimensioned in such a way that it allows the head attached to the pull-mandrel shank to be recessed. This is advantageous because it helps to flatten the resulting profile of the head.

Ideally, this makes it possible to countersink the head of the pull-mandrel flush into the rivet head. This allows the undercut in the composite panel or façade panel respectively to be optimized to the dimensions of the rivet head. The shape of the recess is preferably designed to complement the head of the pull-mandrel.

A further advantage can be achieved if the underside of the mushroom-shaped head of the rivet facing the shank does not form a plane, but has a concave shape and slopes away from the edge towards the shank. The contact surface of the rivet head is thus displaced radially outwards away from the hole. Alternatively, the underside of the mushroom-shaped head of the rivet facing the shank can also be contoured with point or ring-shaped structures that can anchor themselves more firmly in the substrate during installation.

The head shape of the rivet can be circular, square or oval. Depending on the application, one of these basic shapes can be used to advantage.

The rivet is preferably made of aluminum or an aluminum alloy, in particular an aluminum-magnesium alloy, or of stainless or electroplated steel. The design depends on the required performance and/or environmental conditions.

The dimensions of the rivet head, rivet sleeve and pull-mandrel are determined by the type of panel, the wall thickness of the panel holder and the loads that occur and can be determined by testing. The information in the figure description is exemplary.

A fastening arrangement within the meaning of the present invention comprises a façade panel and a panel holder. A plurality of grooves is provided on the rear side of the façade panel. These grooves generally have a keyhole shape, as described above.

Correspondingly, the panel holder has a plurality of through-openings. The fastening between the composite panel/façade panel and the panel holder(s) is produced by a plurality of setting operations in accordance with the method described above. These setting operations are produced for at least a subset of the through-openings by means of a corresponding number of rivets as described above. “Subset” because standard components of panel holders can be provided with a larger number of through-openings than are required for secure fastening in the individual application.

In an advantageous variant, at least two of the keyhole-shaped grooves are arranged in such a way that they have a common longitudinal axis in the assembly position and are arranged relative to each other in such a way that the two retaining areas are located opposite each other at a distance. Consequently, the two insertion openings thus form the longitudinal ends of the two grooves that are furthest apart.

In one embodiment, the axially measured distance D_{N} between the two edges of the retaining areas of the grooves is between 0.5× and 1.5× the axial length of a retaining area.

The advantage of a fastening arrangement with at least two rivets per panel holder is that the rivets are inserted into the two grooves/keyholes with their facing retaining areas and facing away insertion openings from two directions towards each other. As the panel holder preferably has at least two holes to accommodate the shank of the rivet, it also defines the nominal distance between the two rivets. Both these distances and the tolerances in the production of the grooves (by milling out of the panel) can be adjusted so that problem-free assembly is possible. The use of rivets with their force-fit and form-fit fixing creates a very compact, backlash-free connection.

The preparation of the panels, i.e. cutting them to size and milling the keyhole-shaped grooves, is usually carried out using detailed plans in a workshop and the panel holders are only attached on site at the construction site. As the structural and aesthetic specifications are known in advance and the described retaining elements can be standardized, it may also be worthwhile using programmable milling and assembly systems.

The advantage of screw connections is often cited as the ability to loosen the connections in the event of assembly errors or repairs. However, this is also the case with the riveted connection described. The rivet bead on the panel holder can be cut off or drilled out flush with the surface of the panel holder. If care is taken, the panel holder remains undamaged and can be reused. The remaining rivet can be threaded out of the undercut and replaced with a new one.

A façade arrangement on a building structure is hereinafter referred to as a substructure attached to a building structure with at least one profile support, wherein a plurality of façade panels and panel holders are provided by means of fastening arrangements of the type described above.

It is preferable if the hook-shaped anchorage of a panel holder is designed to engage positively in a complementary receptacle of the profile support. For example, the panel holder consists of sections of the profile support and is designed so that the panel holder can engage positively in the profile support in a 180° rotated position.

In a further development of a fastening arrangement, an adjusting element such as a set screw is arranged between the panel holder and the profile support. This makes it possible to adjust the height of the composite panel when it is suspended. Furthermore, it may be provided that a securing element is arranged between the panel holder and the profile support, which mechanically connects the panel holder and the profile support and prevents unintentional loosening of the connection between the panel holder and the profile support. This can be achieved by a screw connection between the panel holder and the profile support, e.g. using self-tapping screws. Detachable clamps or bonding are also possible.

Alternatively, the present invention can also be described as the use of a rivet-fastening or as the use of a rivet-based fastening method for producing a fastening arrangement comprising a façade panel and a panel holder. The rivet is preferably a pull-through rivet with a shank and a mushroom-shaped head, whereby the head and shank have a continuous axial through-opening with a diameter D_{I}. A mandrel with a head and a longitudinally extended mandrel shank can be inserted into the through hole, whereby the diameter of the head D_{K}>D_{I}. Correctly positioned, the head of the mandrel lies against the head of the rivet or is countersunk in a recess on the upper side of the mushroom-shaped head facing away from the shaft.

To establish the rivet-fastening, the two components to be fastened require appropriately dimensioned openings and are then threaded on or attached to the rivet. A rivet setting tool is then placed on the component over the rivet and the mandrel is connected to the setting tool. The tensile force of the setting tool on the mandrel causes the head of the mandrel to move along the axial opening of the rivet. The resulting material displacement leads to a positive fit between the components or the components and the rivet shank respectively. If a façade panel and a panel holder are used as components, as described in the present invention, a corresponding fastening arrangement results. Here, the rivet or respectively its head with the correctly placed mandrel is first inserted into a keyhole-shaped cut-out with an undercut in the façade panel and the panel holder is attached. All variants of façade panels or composite panels, rivets and riveting methods listed in the description of the invention and the figures can be used or described in this way.

### BRIEF DESCRIPTION OF THE DRAWINGS

FIG. 1 shows a retaining device or fastening arrangement according to the prior art.

FIG. 2 shows an embodiment of a retaining device according to the present invention.

FIG. 3 shows a first version of an unassembled pull-through rivet without a pull-mandrel in longitudinal section.

FIG. 4 is a schematic drawing of a groove in a composite panel or façade panel respectively according to the invention.

FIGS. 5A to C show a setting process according to a variant of the invention.

FIG. 6 shows a top view of an exemplary panel holder relative to the two grooves including rivets.

FIG. 7 shows a panel holder in oblique top view.

FIG. 8 shows a longitudinal section through a second version of an unassembled pull-through rivet without a pull-mandrel.

FIG. 9 A-D show alternative embodiments of grooves 150 based on the keyhole design.

### DETAILED DESCRIPTION

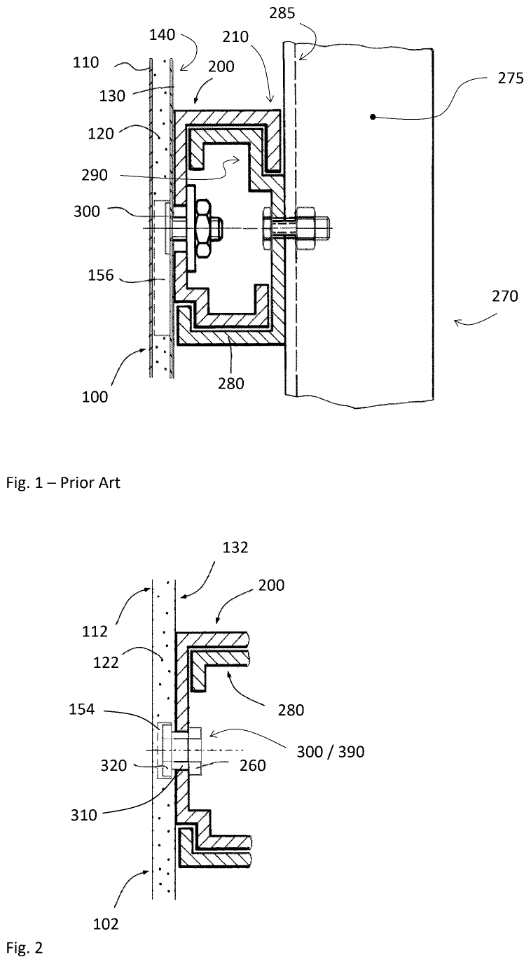

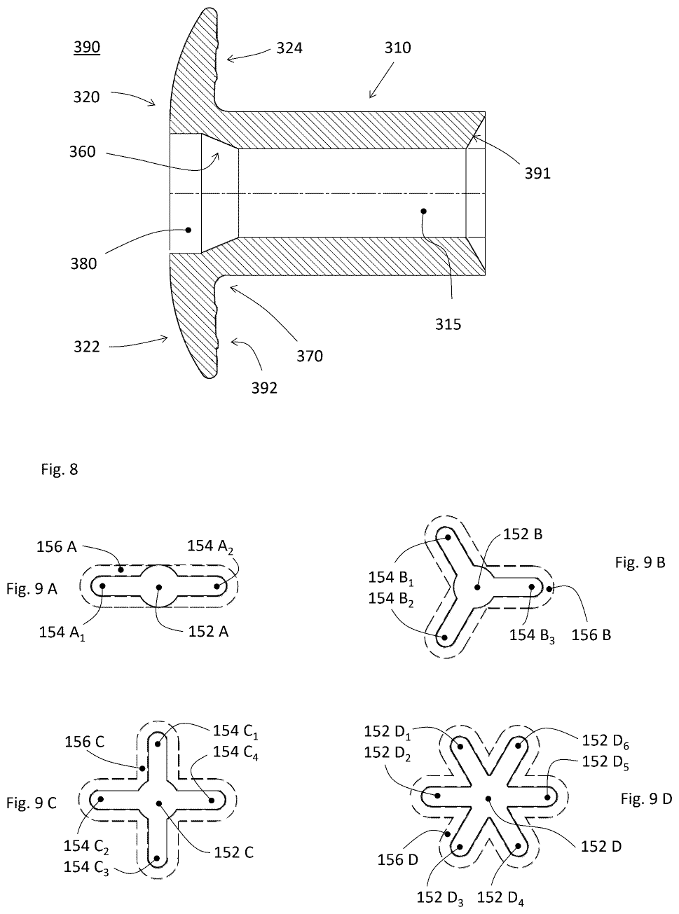

FIG. 1 shows a prior art fastening arrangement for a composite panel façade element 100, which is fastened to a substructure 270 via a panel holder 200 and a profile support 280. Here, the substructure 270 is a vertically arranged T-beam 275, which is attached to a building structure (not shown) via brackets (not shown) and creates a rear-ventilated intermediate space between the building structure and the mounting plane formed by the T-head piece 285. Horizontal profile supports 280 are attached to a plurality of such vertical T-beams 275, in this case by means of bolting. The profile shown in cross-section in FIG. 1 is characterized in that, when turned through 180°, it is suitable for being positively hooked into an identical profile. Sections of the horizontal profile support 280 can therefore be used as panel holders 200 (see FIG. 8), which helps to reduce the variety of components. The projection shown in the picture above is designed as a hook-shaped anchorage 210; it engages behind a part of the profile support 280, which thus acts as a receptacle 290. The structure of the composite panel 100 follows the design already described, comprising a front visible sheet 110, a non-metallic core layer 120 and a rear cover sheet 130. The fastener 300 here is a screwed bolt which engages in an undercut 156 of the core layer 120 and fixes the panel holder 200 to the composite panel 100. Reference mark 140 refers to the rear side of the composite panel.

FIG. 2 shows a retaining device according to the invention. The composite panel 100 with visible sheet 110, core layer 120 and cover sheet 130 is basically identical. A substructure is omitted, panel holder 200 and profile support 280 are only shown in section.

The sectional view shows the horizontal (perpendicular to the drawing plane) elongated hole-shaped retaining area 154 in the undercut. The fastener 300 is designed as a rivet 390. It is shown here in the final assembled state with the mushroom-shaped head 320 in the core layer 120 and the sleeve or shank formed by the setting process, which has formed a forming bead 260. The size and shape of the rivet 390 and the bead 260 are only exemplary.

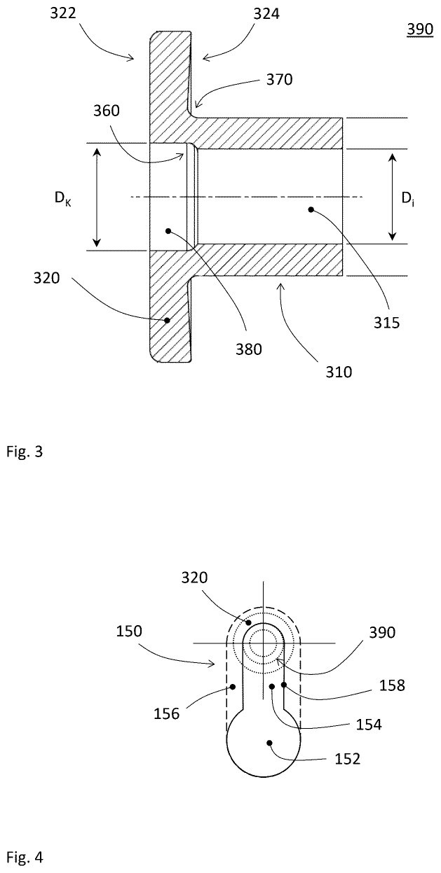

FIG. 3 shows a rivet 390 in a first embodiment in the unassembled state in longitudinal section. It consists of a sleeve-shaped shank 310 with a continuous axial through-opening 315 and a flat, flange-like, mushroom-shaped head 320 with an upper side 322 facing away from the shank and a lower side 324 facing towards the shank. The shank 310 has an internal diameter Dᵢ in its part remote from the head, which is 4.4 mm in a commercial embodiment. The outer diameter of the sleeve in this specific case is 7.3 mm. The head diameter in this version is 15.3 mm. The sleeve is widened in the head area to a diameter D_{K} of 5 mm and thus forms a recess 380. The shoulder 360 marks the transition from D_{K} to Dᵢ. This transition surface also forms the contact surface for the pull-mandrel (not shown here).

The upper side 322 and the underside 324 are not plane-parallel in design. The underside 324 is slightly concave (approx. 0.2 mm on the approx. 5 mm wide circular ring of the underside) and ends in a groove 370 on the shank.

FIG. 4 illustrates the design of a groove 150 in a composite panel according to the present invention. When viewing the back of a corresponding composite panel, the dashed outer border (in the form of a regular elongated hole) marks the overlap of the keyhole contour 158 (solid line) and the undercut 156. The keyhole contour 158 is shown here as a circular insertion opening 152, which merges into an elongated hole-shaped retaining area 154 (solid line). The space between the keyhole contour 158 and the dashed outer border is thus the area of the undercut 156.

An inserted rivet 390 is shown in dotted line in plan view, its flat head 320 is located in the area of the undercut 156. A panel holder is omitted in FIG. 4, as is the outline of the composite panel.

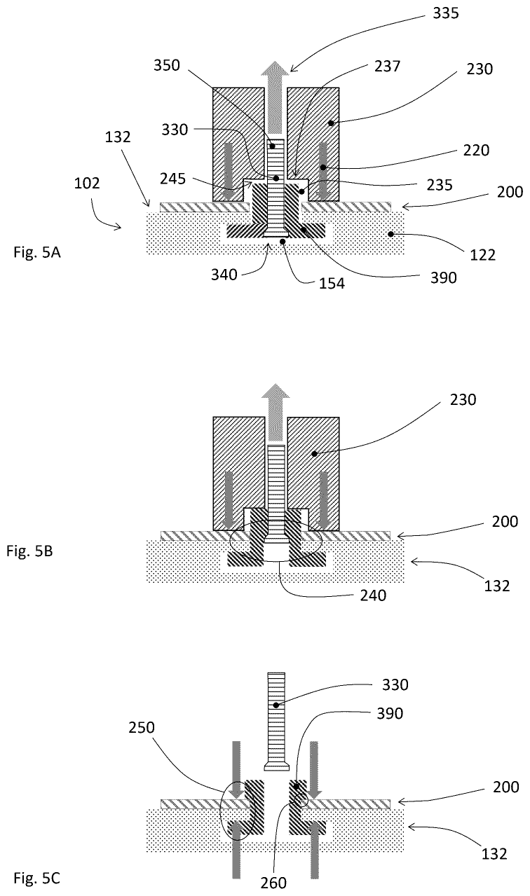

FIGS. 5A to 5C schematically illustrate the setting process according to the method claims. Only the rear cover sheet 130 of a composite panel 100 is shown, the core layer and the visible sheet are not shown. The panel holder 200 is placed on the cover sheet 130 and arranged by a rivet 390 inserted through it as shown in principle in FIG. 4. A pull-mandrel 330 is arranged in the axial through-opening of the rivet 390 in such a way that the pull-mandrel head 340 is recessed flush in the head of the rivet 390. The mouthpiece 230 of a rivet setting tool sits on the panel holder 200, but not on the rivet 390. A gap 245 remains between the end of the rivet shank 310 furthest from the head and the bottom 237 of the cavity 235. During the setting process, the rivet setting tool exerts a tensile force 335 on the pull-mandrel shank 350. A corresponding counterforce (contact force 220) builds up and presses the panel holder 200 and the composite panel 100 (or the rear cover panel 130) together via the head of the hollow rivet 390.

As soon as the tensile force 335 on the mandrel overcomes the resistance of the shoulder 360 (FIG. 3), the head 340 of the pull-mandrel 330 reshapes the material of the shank of the rivet. The radial outward displacement creates a positive fit between the composite panel and the hole in the panel holder. This displacement process is shown in FIG. 5B in the forming area 240. All other features of the drawing correspond to FIG. 5A. The axial displacement fills the gap 245.

FIG. 5C shows the completed setting process. The pull-mandrel 330 has been pulled through completely and has separated from the rivet 390; the material of the rivet shank has been displaced slightly over the edge of the hole in the panel holder 200 as a forming bead 260 (shown here in exaggerated form for clarity). Together with the positive fit, this forming bead 260 thus creates a permanent force-fit connection, as indicated by the arrows of the holding forces 250.

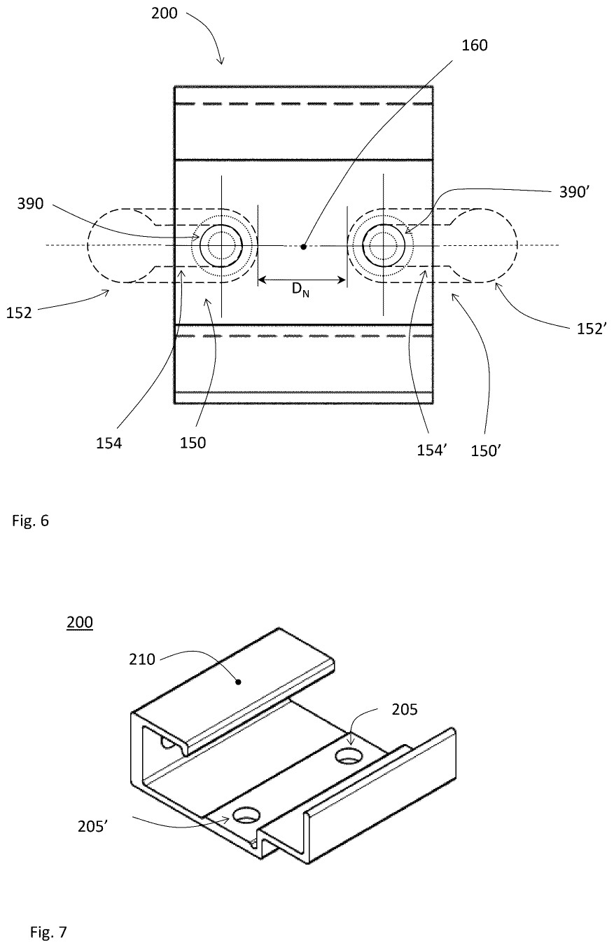

FIG. 6 shows an example of a panel holder 200 and its arrangement relative to the grooves 150, 150′. In the figure “above”, the arrangement of this retaining device corresponds to the mounting on the façade. The grooves 150, 150′ are thus arranged horizontally on a common longitudinal axis 160. The two retaining areas 154 and 154′ of the grooves point towards each other, while the insertion openings 152, 152′ point away from each other. Hollow rivets 390, 390 are again dotted as in FIG. 4. The sleeves are each attached to the longitudinal end of the retaining areas 154, 154′. The distance between the two retaining areas is marked with D_{N}. As the holes in the panel holder must be aligned with the shanks of the hollow rivets 390, 390′, this ensures the precise position of the panel holder on the composite panel. An adjustment error is thus mechanically prevented.

FIG. 7 shows a panel holder 200 with two through-openings 205, 205′ and the hook-shaped anchorage 210. The shape corresponds to the panel holder of FIGS. 1 and 2.

FIG. 8 shows a pull-through rivet or rivet 390 in a second version. The basic structure corresponds to that of FIG. 3 with shank 310, head 320 and axial through-opening 315. The latter also has an enlarged recess 380 and a shoulder 360 at the head end near the top 322. Instead of a concave underside 324, a design with a textured surface 392 was chosen here. These can be, for example, dot-shaped or ring-shaped structures highlighted from the surface. The groove 370 marks the transition between the underside 324 and the surface of the shank 310. In a further embodiment, a funnel-shaped widening 391 directed from the inside to the outside can be provided at the end of the shank 310 remote from the head. This can help to facilitate the formation of the forming bead (260 in FIG. 5C).

FIGS. 9 A-D show alternative embodiments of the design of groove 150 of FIG. 4. The keyhole contour has been further developed in such a way that a common insertion opening 152 A-D opens up different holding areas 154 A-Dx in each case. As can be seen, different geometries can be realized as an overlap of 2, 3, 4 and 6 keyholes. The undercut 156 A-D is only marked once per figure as an example. These designs are technically equivalent to the single keyhole design.

1. A method for manufacturing a fastening assembly including a facade panel and a panel holder, the method comprising:
providing the façade panel as a panel with a homogeneous structure; with a front side, a material layer and a rear side; and
providing at least one keyhole-shaped groove on a rear side of the facade panel; which has a widened insertion opening at a first longitudinal end and an elongated hole-shaped retaining area with an undercut in the core layer at the other longitudinal end; and
providing the panel holder with a through-opening;
forming the mechanical connection between the façade panel and the panel holder by a setting process and a resulting riveted connection, including
providing a rivet, comprising a mushroom-shaped head and a shank, and inserting the head through the insertion opening and into the undercut of the retaining area of the groove in the facade panel so that a free end of the shank protrudes from the rear side of the façade panel;
pushing the panel holder onto the free end of the shank of the rivet via the through-opening so that the panel holder rests on the rear side of the façade plate; and
setting the rivet by forming the free end of the shank with a rivet setting tool such that the rivet creates a positive fit connection between the composite panel and the panel holder.

2. The method according to claim 1, wherein
the rivet comprises a pull-through rivet, and the shank and the head have a continuous axial through-opening with a diameter D_{I},
a pull-mandrel with a head having a head diameter D_{K}>D_{I} and a pull-mandrel shank is provided,
prior to setting the rivet, the pull-mandrel is inserted through the axial through-opening of the rivet so that the pull head of the pull-mandrel rests against the head of the rivet;
the setting is effected by the rivet setting tool actuating the pull-mandrel to form the riveted joint; and
the head of the pull-mandrel is moved along the axial through-opening of the rivet and the positive fit between the facade panel and the panel holder is achieved by material displacement caused thereby.

3. The method according to claim 2, wherein
the rivet setting tool has a tubular mouthpiece with a substantially cylindrical cavity that is axially open on one side and a receptacle for the pull-mandrel shank arranged at a bottom of the cavity,
the method further comprising, for the setting process, arranging the cavity of the mouthpiece above the free end of the shank such that the rivet setting tool is adapted to grip the pull-mandrel shank in a functional manner, and the mouthpiece is arranged to rest on the rear of the panel holder, with a non-contact gap of 0.1 mm-2 mm remaining between the free end of the shank of the rivet and the bottom of the cavity.

4. The method according to claim 3, further comprising the movement of the head of the pull-mandrel along the axial through-opening of the rivet
causing a contact pressure between the mouthpiece resting on the back of the panel holder and the mushroom-shaped head of the rivet
and displacing of the material surrounding the axial passage opening both radially outwards and in an axial pulling direction of the pull-mandrel, wherein the displacement of the material in the axial pulling direction of the pull-mandrel is stopped when the free end of the shank of the rivet strikes the bottom of the cavity,
and the material is only displaced radially outwards.

5. A rivet, comprising:
a shank and a head, wherein the head and shank have a continuous axial through-opening with diameter D_{I};
a pull-mandrel with a head having a head diameter D_{K}>D_{I} and a longitudinally extended pull-mandrel shank; and
wherein the pull-mandrel is insertable into the axial through-opening of the rivet such that in an end position the head of the pull-mandrel rests against the head of the rivet.

6. The rivet according to claim 5, further comprising an axially deepened recess at an upper side of the head facing away from the shank, said recess is dimensioned to allow a countersunk reception of the head attached to the mandrel shank.

7. The rivet according to claim 5, wherein the head is mushroom-shaped and an underside of the mushroom-shaped head of the rivet facing the shank is non-planar, having a concave shape that slopes away from an edge towards the shank.

8. The rivet according to claim 7, wherein the mushroom-shaped head of the rivet has a circular, square or oval basic shape.

9. The rivet according to claim 5, wherein the rivet is made of aluminum, an aluminum alloy, stainless steel, or galvanically coated steel.

10. A fastening arrangement, comprising:
a facade panel;
a panel holder;
a plurality of grooves provided on a rear side of the façade panel;
the panel holder has a plurality of through-openings; and
the fastening between the façade panel and the panel holder is produced by a plurality of setting operations according to the method of claim 1 for at least for a subset of the through-openings using a corresponding number of rivets, each said rivet including:
a shank and a head, wherein the head and shank have a continuous axial through-opening with diameter D_{I};
a pull-mandrel with a head having a head diameter D_{K}>D_{I} and a longitudinally extended pull-mandrel shank; and
wherein the pull-mandrel is insertable into the axial through-opening of the rivet such that in an end position the head of the pull-mandrel rests against the head of the rivet.

11. The fastening arrangement according to claim 10, wherein the grooves are the keyhole-shaped, and at least two of the keyhole-shaped grooves are arranged such that they have a common longitudinal axis in an assembly position and are arranged relative to each other such that two retaining areas of the keyhole-shaped grooves are located opposite each other at a distance.

12. The fastening arrangement according to claim 11, wherein an axially measured distance D_{N} between the two edges of the retaining areas of the grooves corresponds to between 0.5× and 1.5× an axial length of one of the retaining areas.

13. A façade arrangement on a building structure, comprising a substructure attached to a building structure with at least one profile support and a plurality of façade panels and panel holders, produced using a plurality of the fastening arrangements according to claim 10.

14. The façade arrangement according to claim 13, wherein each of the panel holders has a hook-shaped anchorage which is adapted to engage positively in a complementarily designed receptacle of the profile support.

15. The façade arrangement according to claim 13, further comprising an adjusting element arranged between the panel holder and the profile support, said adjusting element mechanically connects the panel holder and the profile support and prevents unintentional loosening of the connection between the panel holder and the profile support.
